(19) United States
(12) Patent Application Publication
(10) Pub. No.: US 2008/0032038 A1
(43) Pub. Date: Feb. 7, 2008

(54) Method for forming functional film and method for manufacturing liquid crystal display

(75) Inventors: Kei Hiruma, Chino-shi (JP); Akinori Hashizume, Chino-shi (JP); Kohei Ishida, Suwa-shi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/878,623

(22) Filed: Jul. 25, 2007

(30) Foreign Application Priority Data
Aug. 2, 2006 (JP) JP 2006-210588
Jul. 10, 2007 (JP) JP 2007-181083

(51) Int. Cl. B05D 5/12

(52) U.S. Cl. 427/58

(57) ABSTRACT

A method for forming a functional film includes a step of preparing a substrate having a surface roughness of 2.3 nm or greater, a step of preparing a functional film forming composition containing functional film forming material and organic solvent, and a step of forming the functional film through ejection of the functional film forming composition onto the substrate using a droplet ejection apparatus.

### CROSS-REFERENCE TO RELATED APPLICATIONS

This application is based upon and claims the benefit of priority from prior Japanese Patent Applications No. 2006-210588, filed on Aug. 2, 2006, and No. 2007-181083, filed on Jul. 10, 2007, the entire contents of which are incorporated herein by reference.

### BACKGROUND

1. Technical Field

The present invention relates to a method for forming a streak free functional film with uniform thickness and a flat surface through application of a functional film forming composition on a substrate using a droplet ejection apparatus and a method for manufacturing a liquid crystal display.

2. Background Art

Typically, to form a liquid crystal alignment film of a liquid crystal display, a method using a liquid crystal ejection apparatus is known. Specifically, a liquid crystal alignment film forming composition is ejected onto a substrate using a droplet ejection apparatus. The composition is then dried to form a film. Subsequently, the formed film is given an orientation force, so that a liquid crystal alignment film is formed. The composition is prepared by dissolving of liquid crystal alignment film forming material, such as polyimide or polyamic acid, in an appropriate solvent.

The method using the droplet ejection apparatus now draws attention because of, for example, the following reasons. Specifically, the method allows for accurate formation of a liquid crystal alignment film with desired thickness at a desirable position. Also, the method involves only a small amount of a liquid crystal alignment film forming composition. However, in this method, a droplet of the composition does not sufficiently wet spread on the substrate, or, in other words, wet spreading performance of the composition is insufficient. This causes streak-like non-uniformity, or generates streaks, on the resulting liquid crystal alignment film. It is thus impossible, disadvantageously, to provide a film with uniform thickness and a flat surface.

To solve this problem, Japanese Laid-Open Patent Publication No. 2004-290961 discloses a method for improving wet spreading performance of a droplet. According to the method, a droplet ejection apparatus ejects droplets onto a substrate at an ejection pitch (the pitch between each adjacent pair of multiple droplet ejection nozzles of the droplet ejection apparatus) equal to a received droplet diameter (the diameter of each droplet that has been received by the substrate). The surface of the substrate is subjected to lyophilic treatment before use. However, even by this method, the wet spreading performance of the droplets becomes insufficient in some types of substrates and streaks may be formed on the obtained liquid crystal alignment film.

### SUMMARY OF THE INVENTION

Accordingly, it is an objective of the present invention to provide a method for forming a streak free functional film having uniform thickness and a flat surface on a substrate using a droplet ejection apparatus, and a method for manufacturing a liquid crystal display.

To achieve the foregoing objective and in accordance with a first aspect of the present invention, a method for forming a functional film is provided. The method includes: preparing a substrate having a surface roughness of 2.3 nm or greater; preparing a functional film forming composition containing a functional film forming material and an organic solvent; and forming a functional film through ejection of the functional film forming composition onto the substrate using a droplet ejection apparatus.

In accordance with a second aspect of the present invention, a method for manufacturing a liquid crystal display is provided. The method includes: preparing a transparent substrate having a transparent conductive film with a surface roughness of 2.3 nm or greater formed on a surface of the substrate; preparing a liquid crystal alignment film forming composition containing a liquid crystal alignment film forming material and an organic solvent; and forming a liquid crystal alignment film through ejection of the liquid crystal alignment film forming composition onto the transparent substrate using a droplet ejection apparatus.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention, together with objects and advantages thereof, may best be understood by reference to the following description of the presently preferred embodiments together with the accompanying drawings in which:

FIG. 1 is a schematic view showing an inkjet ejection apparatus according to one embodiment of the present invention;

FIG. 2 is a cross-sectional view schematically showing a liquid crystal display;

FIG. 3 is a diagram representing an example of a manufacturing line of the liquid crystal display;

FIG. 4 is a flowchart representing a method for manufacturing the liquid crystal display;

FIG. 5 is a diagram representing arrangement of a plurality of inkjet heads;

FIG. 6 is a cross-sectional view showing a portion of the interior of an inkjet head;

FIG. 7 is a plan view schematically showing the ejecting positions relative to the positions of the nozzles and an arrangement pattern of droplets;

FIG. 8 is a view showing an end surface of a substrate when the liquid crystal display is manufactured;

FIG. 9 is a view showing the end surface of the substrate when the liquid crystal display is manufactured;

FIG. 10A is a plan view showing a seal layer for explaining the manufacture of the liquid crystal display;

FIG. 10B is a cross-sectional side view showing the seal layer for explaining the manufacture of the liquid crystal display;

FIG. 11 is a view showing the end surface of the substrate when the liquid crystal display is manufactured;

FIG. 12A is a view showing an end surface of the substrate for explaining a bonding step of the manufacture of the liquid crystal display;

FIG. 12B is a view showing the end surface of the substrate for explaining curing of the seal layer in the manufacture of the liquid crystal display;

FIG. 13 is a plan view schematically showing the ejection positions relative to the positions of the nozzles, and an arrangement pattern of droplets according to a first modified embodiment;

FIG. 14 is a plan view schematically showing the ejection positions relative to the positions of the nozzles and an arrangement pattern of droplets according to a second modified embodiment;

FIG. 15 is a plan view schematically showing the ejection positions relative to the positions of the nozzles and an arrangement pattern of droplets according to a third modified embodiment; and

FIG. 16 is a plan view schematically showing the ejection positions relative to the positions of the nozzles and an arrangement pattern of droplets according to a fourth modified embodiment.

### DESCRIPTION OF THE EXEMPLARY EMBODIMENT

The present invention will now be explained in detail first about a method for forming a functional film and then about a method for manufacturing a liquid crystal display.

### Method for Forming Functional Film

A method for forming a functional film according to the present invention includes a step of preparing a substrate with surface roughness of 2.3 nm or greater, a step of preparing a functional film forming composition, and a step of forming a functional film by ejecting the functional film forming composition using a droplet ejection apparatus. The functional film forming composition contains functional film forming material and organic solvent.

The functional film provided by the method of the invention is a thin functional film formed on a substrate. The functional film may be, for example, a liquid crystal alignment film, an overcoat film, a color filter film, or a photo-resist film, which are formed on a transparent substrate, or a conductive film formed on a circuit substrate, or an electrode film formed on a current collector. Particularly, a liquid crystal alignment film formed on a transparent substrate having a transparent conductive film is preferable as the functional film.

### Substrate

A substrate according to the present invention has a surface roughness of 2.3 nm or greater, or, preferably, 2.3 to 4.0 nm. In the invention, the surface roughness represents centerline average roughness (Ra). The surface roughness (Ra) of the substrate is measurable using, for example, an atomic force microscope (AMF). If a foundation layer, which is, for example, a transparent conductive film, is formed on the surface of the substrate, the foundation layer has surface roughness (Ra) of 2.3 nm or greater. In other words, in this application, the surface roughness of the substrate represents the surface roughness of the substrate if the substrate does not include the foundation layer and the surface roughness of the foundation layer if the substrate includes the foundation layer.

The material of the substrate is not particularly restricted and may be, for example, glass, silicone, quartz, ceramic, metal, and plastic. The substrate may be formed of a single type of material or two or more types of materials in combination. As the substrate, a single layer substrate or a substrate formed by multiple stacked layers may be used. Alternatively, a substrate having a foundation layer, which is, for example, a semiconductor film, a metal film, a dielectric film, an organic film, or a conductive film, formed on the surface may be used. Particularly, in formation of the liquid crystal alignment film, it is preferred that a transparent substrate having a transparent conductive film formed on a surface of the substrate be used as the substrate.

The transparent substrate may be formed of, for example, glass or plastic. The glass may be, for example, float glass or soda glass. The plastic may be, for example, polyethylene terephthalate, polybutylene terephthalate, polyether sulfone, or polycarbonate. The transparent conductive film may be, for example, an NESA film (a registered trademark of PPG Industries of the United States of America) formed of tin oxide (SnO₂) or an ITO (Indium Tin Oxide) film formed of indium oxide-tin oxide (In₂O₃—SnO₂).

The method for forming the transparent conductive film on the transparent substrate is not particularly restricted and may be, for example, a sputtering method, an ion plating method, or a vacuum vapor deposition method.

According to the present invention, use of a substrate having surface roughness (Ra) of 2.3 nm or greater improves wet spreading performance of droplets of a functional film forming composition on a surface of a substrate. Particularly, the method of the invention provides enhanced coatability by the droplet ejection apparatus. Thus, even if the functional film forming composition exhibits poor wet spreading performance on the surface of the substrate, a streak free functional film having uniform thickness and a flat surface is easily formed.

The method for ensuring a surface roughness (Ra) of 2.3 nm or greater of the substrate is not particularly restricted and may be a publicly known roughening treatment method. The method may involve, for example, a roughening treatment performed on the surface of the substrate using an agent such as an organic acid or permanganate. If a transparent conductive film is formed on a transparent substrate, the surface roughness (Ra) of the transparent conductive film is set to a value of not less than 2.3 nm through adjustment of the film depositing conditions. If a sputtering method is employed, such conditions include, for example, sputtering temperature and gas pressure.

According to the present invention, it is preferable to employ a substrate that has surface roughness (Ra) of 2.3 nm or greater and includes a surface that has been subjected to lyophilic treatment. The lyophilic treatment, which is performed on the surface of the substrate, increases wettablility of the functional film forming composition with respect to the surface of the substrate. It is thus easy to form a functional film having further uniform thickness and a further flat surface.

The method for performing the lyophilic treatment on the surface of the substrate is not particularly restricted and may be a publicly known method. The method may be, for example, an ultraviolet treatment method or a plasma treatment method. In other words, any suitable method may be employed as long as the surface roughness (Ra) of the substrate does not change greatly in a majority of cases before and after the lyophilic treatment and the surface roughness (Ra) of the surface of the substrate is 2.3 nm or greater after completion of the lyophilic treatment.

### Functional Film Forming Composition

A functional film forming composition according to the present invention contains a functional film forming material and an organic solvent. The type of the functional film forming material is not particularly restricted. If the functional film is, for example, a conductive film formed on a circuit substrate, a conductive material is used as the functional film forming material. If the functional film is, for example, an electrode film formed on a current collector, an electrode material is used as the functional film forming material. If the functional film is, for example, a liquid crystal alignment film formed on a transparent substrate, a liquid crystal alignment film forming material is used as the functional film forming material. In particular, a liquid crystal alignment film forming material for forming a liquid crystal alignment film on a transparent substrate including a transparent conductive film is preferable as the functional film forming material.

The type of the liquid crystal alignment film forming material is not particularly restricted and may be a publicly known liquid crystal alignment film forming material. Such material may be, for example, polyamic acid, polyimide, polyamic acid ester, polyester, polyamide, polysiloxane, cellulose derivative, polyacetal, polystyrene derivative, poly(styrene-phenylmaleimide) derivative, or poly(metha)acrylate.

For example, a copolymer having at least one type selected from a repeating unit represented by the formula (I) and the repeating unit represented by the formula (II) allows formation of an alignment film having improved orientation force of liquid crystal. It is thus preferred that a copolymer be used as the liquid crystal alignment film forming material.

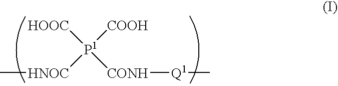

In the formula, P¹ represents a quadrivalent organic group and Q¹ represents a bivalent organic group.

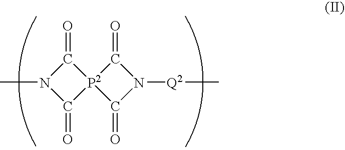

In the formula, P² represents a quadrivalent organic group and Q² represents a bivalent organic group.

Such a copolymer may be, for example, (i) polyamic acid having the repeating unit represented by the formula (I), (ii) imidized copolymer having the repeating unit represented by the formula (II), or (iii) block copolymer including amic acid prepolymer having the repeating unit represented by the formula (I) and imide prepolymer having the repeating unit represented by the formula (II). A single type of the listed materials may be employed solely or two or more types of these materials may be used in combination. In the latter case, it is preferred that the polyamic acid and the imidized copolymer be used as a mixture. The average molecular weight of the copolymer is not particularly restricted and is normally not less than 170,000.

The type of organic solvent contained in the functional film forming composition is not particularly restricted as long as the solvent uniformly dissolves or disperses the functional film forming material. The organic solvent may be, for example, a good solvent of the polyamic acid, such as an aprotic polar solvent or a phenol-based solvent.

The aprotic polar solvent may be, for example, amid-based solvent, sulfoxide-based solvent, ether-based solvent, or nitrile-based solvent. The amid-based solvent may be, for example, γ-butyrolactone, N-methyl-2-pyrrolidone, N,N-dimethylacetamide, N,N-dimethylformamide, hexamethylphosphoramide, or tetramethylurea. The sulfoxide-based solvent may be, for example, dimethyl sulfoxide or diethyl sulfoxide.

The phenol-based solvent may be, for example, cresol, xylenol, phenol, or halogenated phenol. As the cresol, o-cresol, m-cresol, or p-cresol, for example, may be employed. As the xylenol, o-xylenol, m-xylenol, or p-xylenol, for example, may be employed. As the halogenated phenol, o-chlorophenol, m-chlorophenol, o-bromophenol, or m-bromophenol, for example, may be employed. Each of the listed substances may be used solely or two or more types of the substances may be employed in combination.

As the organic solvent, a poor solvent for polyamic acid may be appropriately selected and used in combination with the aforementioned solvents. As a poor solvent of polyamic acid, alcohol-based solvent, ketone-based solvent, ether-based solvent, ester-based solvent, halogenated hydrocarbon-based solvent, aliphatic hydrocarbon-based solvent, or aromatic hydrocarbon-based solvent, for example, may be employed.

The alcohol-based solvent may be, for example, methanol, ethanol, isopropyl alcohol, cyclohexanol, 4-hydroxy-4-methyl-2-pentanone (diacetone alcohol), ethylene glycol, propylene glycol, 1,4-butanediol, or triethylene glycol. The ketone-based solvent may be, for example, acetone, methyl ethyl ketone, methyl isobutyl ketone, or cyclohexanone.

The ether-based solvent may be, for example, ethylene glycol monomethyl ether, diethyl ether, ethylene glycol methyl ether, ethylene glycol ethyl ether, ethylene glycol-n-propyl ether, ethylene glycol isopropyl ether, ethylene glycol-n-butyl ether (butyl cellosolve), ethylene glycol dimethyl ether, ethylene glycol ethyl ether acetate, diethylene glycol dimethyl ether, diethylene glycol diethyl ether, diethylene glycol monomethyl ether, diethylene glycol monoethyl ether, diethylene glycol monomethyl ether acetate, diethylene glycol monoethyl ether acetate, or tetrahydrofuran.

The ester-based solvent may be, for example, ethyl lactate, butyl lactate, methyl acetate, ethyl acetate, butyl acetate, methyl methoxypropionate, ethyl ethoxypropionate, diethyl oxalate, or diethyl malonate. The halogenated hydrocarbon-based solvent may be, for example, dichloromethane, 1,2-dichloroethane, 1,4-dichlorobutane, trichloroethane, chlorobenzene, or o-dichlorobenzene. The aliphatic hydrocarbon-based solvent may be, for example, n-hexane, n-heptane, or n-octane. The aromatic hydrocarbon-based solvent may be, for example, benzene, toluene, or xylene.

To enhance bonding between the functional film and the surface of the substrate, the functional film forming composition may contain functionalized-silane-containing compound or epoxy-group-containing compound, in addition to the functional film forming material and the organic solvent. Neither the type of the functional-silane-containing compound nor the type of the epoxy-group-containing compound is particularly restricted, and, as these compounds, known types may be employed. The functional film forming composition is produced through dissolving or dispersion, or, preferably, dissolving, of the functional film forming material and, if desired, the functional-silane-containing compound, for example, in the organic solvent at a desired mixing rate.

A functional film forming composition according to the present invention exhibits an improved elastic property and enhanced stability when ejected. This provides a functional film having further uniform thickness and a further flat surface. It is thus preferred that the functional film forming composition have solid content concentration, viscosity, and surface tension in the following ranges.

Specifically, the solid content concentration of the functional film forming composition is preferably, 1 to 10 wt %, and, more preferably, 1 to 4 wt %, with respect to the composition as a whole. If the solid content concentration is less than 1 wt % with respect to the composition as a whole, the thickness of the functional film may become excessively small. In this case, it is likely that the obtained functional film is not optimal. If the solid content concentration exceeds 10 wt %, the thickness of the functional film may become excessively great, making it likely that the effective functional film is not obtained. Also, in this case, the viscosity of the functional film forming composition may increase, which deteriorates the coatability.

The viscosity of the functional film forming composition at 23° C. is preferably 3 to 20 mPa·s, and, more preferably, 3 to 8 mPa·s. As long as the viscosity of the composition is adjusted in this range, the functional film forming composition exhibits improved flowability, thus stabilizing ejection performance by the droplet ejection apparatus.

The surface tension of the functional film forming composition at 23° C. is preferably 30 to 45 mN/m, and, more preferably, 35 to 45 mN/m. If the surface tension of the functional film forming composition falls in this range, the composition exhibits enhanced wettability with respect to the surface of the substrate. Thus, a film with uniform thickness is efficiently formed using the droplet ejection apparatus.

According to the present invention, the functional film forming composition having the above-described physical properties is ejected onto the substrate with a surface roughness (Ra) of 2.3 nm or greater using the droplet ejection apparatus. In this manner, a streak free functional film having uniform thickness and a flat surface is easily formed. This greatly increases yield.

### Droplet Ejection Apparatus

According to the present invention, the functional film is formed on the substrate by a method involving ejection of the functional film forming composition onto the substrate using a droplet ejection apparatus.

The type of droplet ejection apparatus employed in the method is not particularly restricted as long as an inkjet ejection apparatus is selected. As the droplet ejection apparatus, a thermal ejection apparatus that ejects droplets using bubbles generated through heating and foaming or a piezoelectric ejection apparatus that ejects droplets through compression using a piezoelectric element, for example, may be employed.

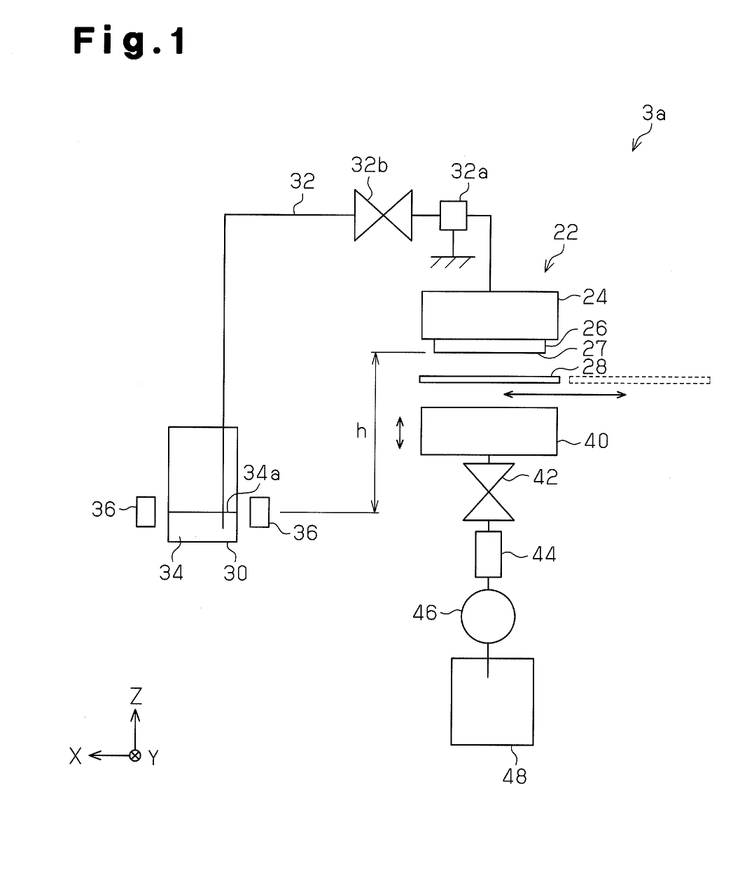

FIG. 1 shows an example of the droplet ejection apparatus according to the present invention. In the drawing, the configuration of an inkjet droplet ejection apparatus 3a is schematically shown. The droplet ejection apparatus 3a has an inkjet head 22, which ejects the matter-to-be-ejected 34 (the functional film forming composition) onto a substrate as droplets. The inkjet head 22 includes a head body 24 and a nozzle plate 26. The nozzle plate 26 has a nozzle forming surface 27 in which a number of nozzles are provided to eject the ejection matter 34 as droplets. The substrate is arranged to be opposed to and parallel with the nozzle forming surface 27. The ejection matter 34 is ejected from the nozzles as the droplets onto the substrate.

The droplet ejection apparatus 3a has a table 28 on which the substrate is mounted. The table 28 is arranged in a manner movable in predetermined directions, which are, for example, an x direction (the main scanning direction), a y direction (the sub-scanning direction), and a z direction (the direction defined by height). As indicated by the corresponding arrows in FIG. 1, the table 28 moves along the x direction (the main scanning direction). In this manner, after having been transported by a belt conveyor 10 (see FIG. 3), the substrate is mounted on the table 28 and set in the droplet ejection apparatus 3a.

A tank 30 is connected to the inkjet head 22. The tank 30 retains the ejection matter 34, which is to be ejected from the nozzles formed in the nozzle forming surface 27. That is, the tank 30 and the inkjet head 22 are connected together through an ejection matter transport pipe 32, which transports the ejection matter 34. The ejection matter transport pipe 32 has an ejection matter line earth coupling 32a, which prevents the interior in the ejection matter transport pipe 32 from being charged, and a head bubble removal valve 32b. The head bubble removal valve 32b is used when a suction cap 40, which will be explained later, draws the ejection matter 34 from inside the inkjet head 22. In other words, when the suction cap 40 draws the ejection matter 34 from inside the inkjet head 22, the head bubble removal valve 32b is closed to stop the ejection matter 34 from flowing from the tank 30 to the inkjet head 22. Suction of the ejection matter 34 by the suction cap 40 increases the flow rate of the ejection matter 34 when the ejection matter 34 is drawn. This quickly removes bubbles from inside the inkjet head 22.

The droplet ejection apparatus 3a has a liquid level control sensor 36, which controls the amount of the ejection matter 34 in the tank 30, or the height of a surface 34a of the ejection matter 34 retained in the tank 30. The liquid level control sensor 36 operates to maintain the difference h between the height of the nozzle forming surface 27 of the nozzle plate 26, which is provided in the inkjet head 22, and the height of the surface 34a of the ejection matter 34 in the tank 30 in a predetermined range. Through such controlling of the height of the surface 34a, the ejection matter 34 is sent from the tank 30 to the inkjet head 22 under pressure in a predetermined range. This allows stable ejection of the ejection matter 34 by the inkjet head 22.

The suction cap 40 is arranged to be opposed to the nozzle forming surface 27 of the inkjet head 22 and spaced from the nozzle forming surface 27 by a certain distance. The suction cap 40 draws the ejection matter 34 from inside the nozzles of the inkjet head 22. The suction cap 40 is movable along the z direction indicated by the corresponding arrow in FIG. 1. The suction cap 40 tightly contacts the nozzle forming surface 27 in such a manner as to encompass the nozzles formed in the nozzle forming surface 27. This defines a tightly sealed space between the suction cap 40 and the nozzle forming surface 27 and separates the nozzles from the atmospheric air.

The suction cap 40 draws the ejection matter 34 from inside the nozzles of the inkjet head 22 when ejection of the ejection matter 34 by the inkjet head 22 is suspended, or, for example, when the inkjet head 22 is retracted at a retreat position and the table 28 is retracted at the position indicated by the broken lines in FIG. 1. A passage is provided below the suction cap 40 and receives a suction valve 42, a suction pressure sensor 44, which detects a defect in suction, and a suction pump 46, which is formed by, for example, a tube pump. After having been drawn by the suction pump 46 and the like, the ejection matter 34 is transported through the passage and collected in a waste liquid tank 48.

Using the droplet ejection apparatus 3a, a droplet of the functional film forming composition (the ejection matter 34) is ejected onto a prescribed area on the substrate by a predetermined amount. Subsequently, the organic solvent is allowed to dry and evaporate from the resulting film of the functional film forming composition. The film is then heated, as desired, to provide a target functional film.

The substrate used in the method for forming a functional film according to the present invention allows the droplet ejected by the droplet ejection apparatus 3a, or the droplet of the functional film forming composition, to exhibit improved wettability on the substrate. Thus, a streak free functional film having uniform thickness and a flat surface is easily formed without employing a functional film forming composition with particularly enhanced wettability. This greatly increases the yield.

### Method for Forming Liquid Crystal Display

A method for forming a liquid crystal display according to the present invention includes a step of preparing a transparent substrate having a transparent conductive film formed on a surface of the substrate, a step of preparing a liquid crystal alignment film forming composition, and a step of forming a liquid crystal alignment film through ejection of the liquid crystal alignment composition onto the transparent substrate using a droplet ejection apparatus. The liquid crystal alignment film forming composition contains liquid crystal alignment film forming material and organic solvent. As the substrate, a transparent substrate having a transparent conductive film with a surface roughness (Ra) of 2.3 nm or greater is employed. According to the present invention, it is preferable to use a liquid crystal alignment film forming composition having a solid content concentration of 1 to 10 wt % with respect to the composition as a whole, a viscosity of 3 to 20 mPa·s at 23° C., a surface tension of 30 to 45 mN/m at 23° C., as the liquid crystal alignment film forming composition.

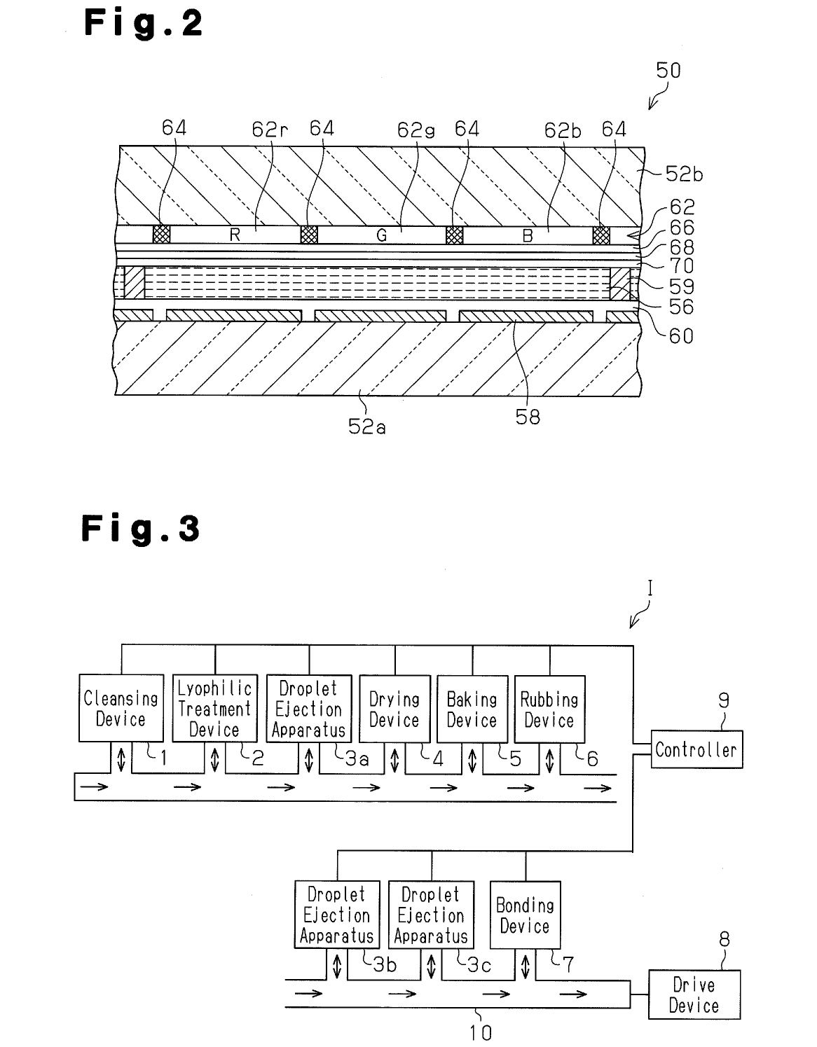

The present invention will hereafter be explained with regard to the manufacture of a liquid crystal display shown in FIG. 2. A liquid crystal display 50, which is shown in the drawing, is a passive matrix type semi-transmissive reflective color liquid crystal display. The liquid crystal display 50 has a lower substrate 52a, which is shaped as a flat rectangular plate, and an upper substrate 52b. The lower substrate 52a and the upper substrate 52b are opposed to each other through a seal material and a spacer 59. The lower substrate 52a is formed of, for example, glass or plastic. A liquid crystal layer 56 is formed in the space between the lower substrate 52a and the upper substrate 52b, which is encompassed by the seal member.

A plurality of segment electrodes 58 and a liquid crystal alignment film 60 are provided, in this order from the side corresponding to the lower substrate 52a, between the lower substrate 52a and the liquid crystal layer 56. As shown in FIG. 2, the segment electrodes 58 are arranged in a striped manner and each formed by, for example, a transparent conductive film such as an ITO film. The liquid crystal alignment film 60 is formed of a liquid crystal alignment film forming material.

A color filter 62, an overcoat film 66, a common electrode 68, and a liquid crystal alignment film 70 are provided, in this order from the side corresponding to the upper substrate 52b, between the upper substrate 52b and the liquid crystal layer 56. The color filter 62 is formed by pigment layers 62r, 62g, and 62b of red (R), green (G), and blue (B), respectively. A black matrix 64 is arranged (in the boundary) between each adjacent pair of the pigment layers 62r, 62g, 62b, which form the color filter 62. Each of the black matrices 64 is formed of resin black or metal with low light reflectivity. As such metal, chrome (Cr), for example, may be used. The pigment layers 62r, 62g, 62b of the color filter 62 oppose the corresponding segment electrodes 58, which are formed on the lower substrate 52a.

The overcoat film 66 evens the steps between the pigment layers 62r, 62g, 62b and protects the surfaces of the pigment layers. The overcoat film 66 is formed of acrylic resin, polyimide resin, or by an inorganic film. A silicone oxide film, for example, may be employed as the inorganic film. The common electrode 68 is formed by a transparent conductive film such as an ITO film. The common electrode 68 is formed in a striped manner extending in a direction perpendicular to the segment electrodes 58, which are provided on the lower substrate 52a. The liquid crystal alignment film 70 is formed of, for example, polyimide resin.

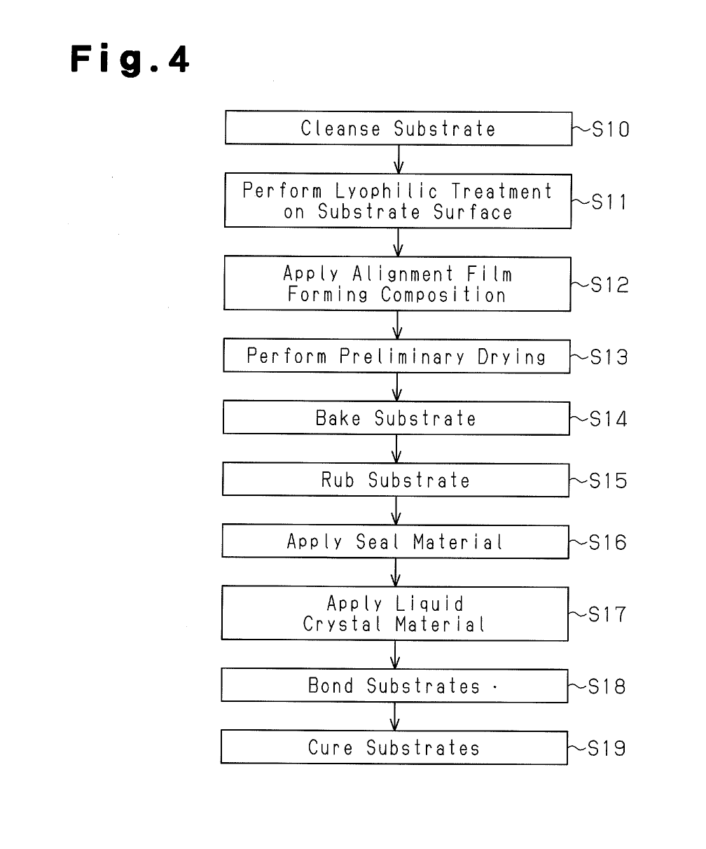

The liquid crystal display 50, which is shown in FIG. 2, is manufactured through steps S10 to S19 in FIG. 4 using the manufacturing line of the liquid crystal display 50 shown in FIG. 3. With reference to FIG. 3, the liquid crystal display manufacturing line I includes a cleansing device 1, a lyophilic treatment device 2, a droplet ejection apparatus 3a, a drying device 4, a baking device 5, a rubbing device 6, a droplet ejection apparatus 3b, a droplet ejection apparatus 3c, a bonding device 7, a belt conveyor 10, which connects the aforementioned devices and apparatuses together, a drive device 8, and a control device 9, which are operated in each of the steps. The drive device 8 drives the belt conveyor 10 and the control device 9 controls operation of the liquid crystal display manufacturing line I as a whole. In the illustrated embodiment, which will be explained in the following, each of the droplet ejection apparatuses 3b, 3c is configured identically with the droplet ejection apparatus 3a shown in FIG. 1, except for that the droplet ejection apparatuses 3b, 3c eject material different from the material to be ejected by the droplet ejection apparatus 3a.

First, the lower substrate 52a, which is formed by a transparent substrate, is prepared. Transparent conductive films (the segment electrodes 58) are then deposited on the surface of the lower surface 52a in which the liquid crystal alignment film 60 is to be formed using a sputtering method. In sputtering, the sputtering temperature and pressure are controlled in such a manner that each of the completed transparent conductive films has surface roughness (Ra) of 2. 3 nm or greater. In the illustrated embodiment, the lower substrate 52a in which the segment electrodes 58 are formed is provided in this manner.

### S10: Cleansing of Substrate

The surface of the lower substrate 52a in which the liquid crystal alignment film 60 is to be formed is cleansed. The lower substrate 52a (hereinafter, referred to simply as the “substrate”), in which the segment electrodes 58 have been provided, is transported to and set in the cleansing device 1. The lower substrate 52a is then cleansed using, for example, an alkaline cleansing agent or pure water and subjected to drying treatment at a predetermined temperature for a predetermined time, which are, for example, at 80° C. to 90° C. for 5 to 10 minutes. After having been cleansed and dried, the lower substrate 52a is transported to the lyophilic treatment device 2 by the belt conveyor 10.

### S11: Lyophilic Treatment on the Surface of the Substrate

The surface of the lower substrate 52a, which has been cleansed and dried, is then subjected to lyophilic treatment. Specifically, after having been transported to the lyophilic treatment device 2 by the belt conveyor 10, the lower substrate 52a is set in the lyophilic treatment device 2. The lyophilic treatment is then performed on the surface of the lower substrate 52a. As the lyophilic treatment device 2, an ultraviolet ray treatment device or a plasma treatment device may be employed. Through the lyophilic treatment on the surface of the lower surface 52a, the wettability of the liquid crystal alignment film forming composition is further enhanced. Thus, the liquid crystal alignment film 60 having further uniform thickness and a further flat surface is formed on the lower substrate 52a.

### S12: Application of Alignment Film Forming Composition

After the lyophilic treatment on the lower substrate 52a in step S11, the liquid crystal alignment film forming composition is applied onto the lower substrate 52a. As the liquid crystal alignment film forming composition, a composition containing a liquid crystal alignment film forming material and organic solvent, and having a solid content concentration of 1 to 10 wt %, a viscosity of 3 to 20 mPa·S at 23° C., and a surface tension of 30 mN/m at 23° C., is employed.

After the lyophilic treatment on the surface of the lower substrate 52a, the lower substrate 52a is transported to the droplet ejection apparatus 3a by the belt conveyor 10. The lower substrate 52a is then mounted on a table 28 and thus set in the droplet ejection apparatus 3a. In the droplet ejection apparatus 3a, the liquid crystal alignment film forming material (the ejection matter 34), which is retained in the tank 30, is ejected through the nozzles of the nozzle plate 26. In this manner, the liquid crystal alignment film forming composition is applied onto the lower substrate 52a.

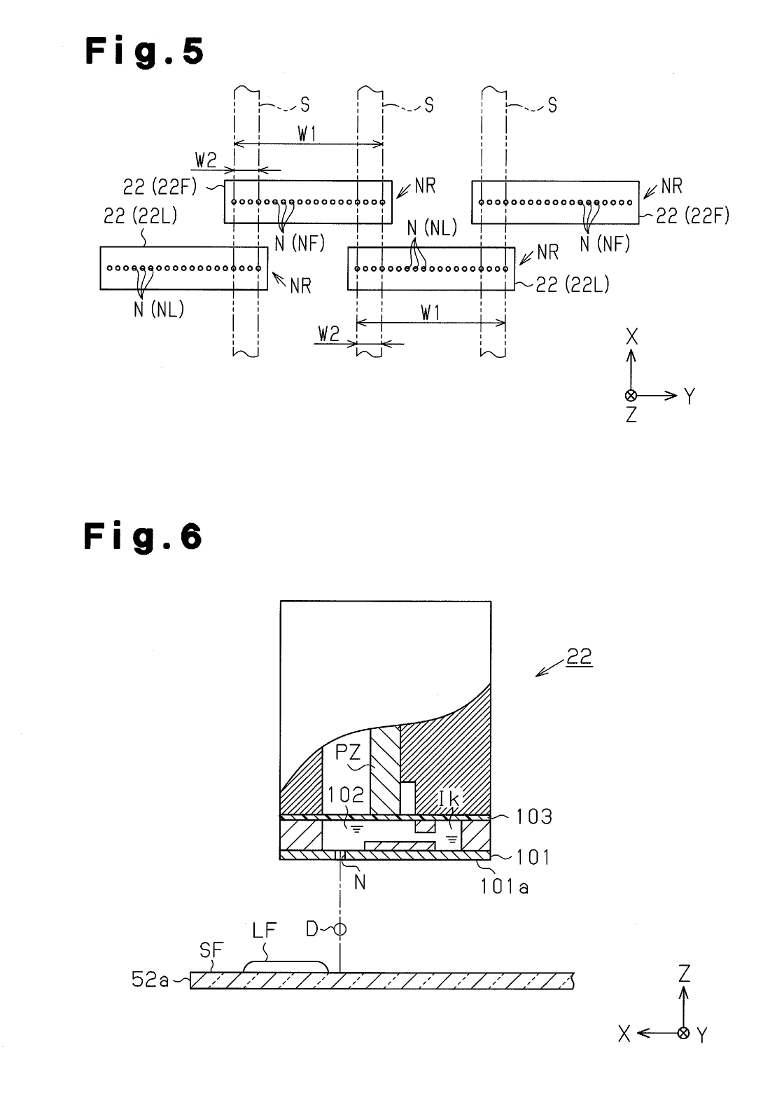

Application of the liquid crystal alignment film forming composition on the lower substrate 52a using the droplet ejection apparatus 3a will be explained, by way of example, with reference to FIGS. 5 to 7. As shown in FIG. 5, the droplet ejection apparatus 3a has a plurality of inkjet heads 22. The inkjet heads 22 are arranged in a zigzag manner along the sub-scanning direction (the y direction). Such arrangement of the inkjet heads 22 allows the droplet ejection apparatus 3a to apply the liquid crystal alignment film forming composition on the substantially entire portion of the lower substrate 52a through a single cycle of scanning of the lower substrate 52a in the scanning direction (the x direction).

180 nozzles N are formed on a nozzle forming surface 101a of a nozzle plate 101 of each inkjet head 22. The nozzles N extend through the nozzle plate 101 in a normal direction (the z direction) of the nozzle forming surface 101a. The nozzles N are spaced at equal intervals along the sub-scanning direction of each inkjet head 22. The nozzles N form a single nozzle row NR as a nozzle group.

The inkjet heads 22 located rearward in the scanning direction (the x direction) are referred to as preceding inkjet heads 22L. The nozzles N of each of the preceding inkjet heads 22 are referred to as the preceding nozzles NL, or first nozzles. The inkjet heads 22 located forward in the scanning direction (the x direction) are referred to as following inkjet heads 22F. The nozzles N of each of the following inkjet heads 22F are referred to as the following nozzles NF, or second nozzles. In FIG. 5, some of the nozzles N are not shown for the sake of easier understanding of arrangement of the inkjet heads 22.

A portion of the nozzle row NR of each of the preceding inkjet heads 22L and a portion of the nozzle row NR of the adjacent one of the following inkjet heads 22F are overlapped with each other at a predetermined proportion as viewed in the main scanning direction. The positions of the preceding nozzles NL and the positions of the following nozzles NF substantially coincide with each other in each of the overlapped areas of the nozzle rows NR, as viewed in the scanning direction.

The width of each of the nozzle rows NR is referred to as a nozzle row width W1. The width of the overlapped area between each adjacent pair of the nozzle rows NR is referred to as an overlapping width W2. The ratio of the overlapping width W2 with respect to the nozzle row width W1 is referred to as the “overlapping ratio”. To suppress streaking of the liquid crystal alignment film 60 formed on the lower substrate 52a, it is preferred that the overlapping ratio be 5% to 40%. If the overlapping ratio is less than 5%, streaks may be formed between the portion of the liquid crystal alignment film 60 formed by the preceding nozzles NL and the portion of the liquid crystal alignment film 60 formed by the following nozzles NF. If the overlapping ratio exceeds 40%, the amount of overlapping between the preceding inkjet heads 22L and the corresponding following inkjet heads 22F may increase. In this case, the number of the inkjet heads 22 must be increased.

When the lower substrate 52a is scanned in the main scanning direction, each of the following inkjet heads 22F forms a scanning path that overlaps the scanning path of the adjacent one of the preceding inkjet heads 22L by the amount corresponding to the overlapping rate. In this manner, the following inkjet heads 22F cover the areas between the adjacent pairs of the preceding inkjet heads 22L. This forms elongated overlapping areas S, which has the overlapping width W2 and extends in the main scanning direction, on an ejection surface SF of the lower substrate 52a. Each of the overlapping areas S is provided as an area in which the scanning path of the corresponding one of the preceding inkjet heads 22L overlaps the scanning path of the adjacent one of the following inkjet heads 22F.

As illustrated in FIG. 6, a cavity 102 is provided above each of the nozzles N and communicates with the ink tank 30. Each of the cavities 102 retains the liquid crystal alignment film forming composition (hereinafter, referred to as alignment film forming ink Ik), which is sent from the ink tank 30, and supplies the ink to the associated one of the nozzles N. An oscillation plate 103 is bonded with the tops of the walls defining each cavity 102 and oscillates in a vertical direction. The oscillation plate 103 thus increases and decreases the volume of the associated cavity 102. A piezoelectric element PZ is formed on each of the oscillation plates 103. When a drive waveform signal is input to each of the piezoelectric elements PZ so as to drive the piezoelectric elements PZ, the piezoelectric elements PZ contract and extend in the vertical direction to oscillate the associated oscillation plates 103.

Each cavity 102 oscillates the meniscus in the corresponding nozzle N in the vertical direction when the associated oscillation plate 103 oscillates. The cavity 102 thus causes the associated nozzle N to eject the alignment film forming ink Ik as a droplet D by the weight defined in correspondence with the drive waveform signal. Each of the droplets D then travels substantially along a normal line of the lower substrate 52a and reaches the ejection surface SF of the lower substrate 52a opposed to the associated one of the nozzles N. Afterwards, the droplets D join together on the ejection surface SF to form a liquefied film LF. The solvent or the dispersion medium is then evaporated from the liquefied film LF on the ejection surface SF through a prescribed drying procedure. This provides the liquid crystal alignment film 60 without orientation force with respect to liquid crystal molecules.

The droplet D ejected from each of the preceding nozzles NL is referred to as a “preceding droplet,” and the portions of the liquid crystal alignment film 60 formed by the preceding droplets are referred to as “preceding alignment film portions”. The droplet D ejected from each of the following nozzles NF is referred to as a “following droplet,” and the portions of the liquid crystal alignment film 60 formed by the following droplets are referred to as “following alignment film portions”.

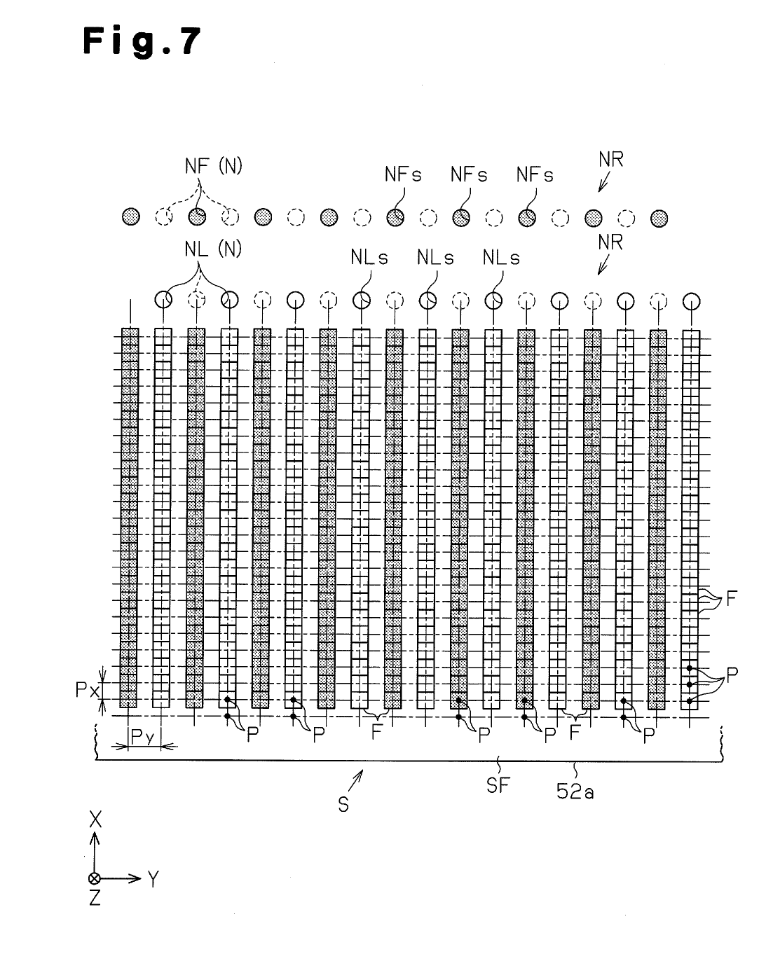

FIG. 7 schematically illustrates the ejecting positions of the droplets D defined on the ejection surface SF and the nozzles N associated with the ejecting positions. In other words, the illustration represents a dot pattern. In FIG. 7, the right side of the ejection surface SF corresponds to the scanning areas of the preceding inkjet heads 22L and the left side of the ejection surface SF corresponds to the scanning areas of the following inkjet heads 22F. Further, the ejection surface SF is virtually divided by a dot pattern grid, which is indicated by the single-dotted chain lines. The dot pattern grid is a grid defined by an ejection pitch Px extending in the main scanning direction and an ejection pitch Py extending in the sub-scanning direction. Whether the droplet should be ejected is determined in accordance with the grid points P of the dot pattern grid.

Each of the grid points P located at the ejecting positions is encompassed by a rectangular frame (hereinafter, referred to as an ejection frame F). Each of the nozzles N selected to perform ejection onto a filled-in ejection frame F is represented by a filled-in section. Each of the nozzles N selected to perform ejection onto a blank ejection frame F is represented by a blank section. The nozzles N that are selected to perform ejection are indicated by solid lines and the nozzles N that are not selected for ejection are indicated by chain lines. The preceding nozzles NL selected to perform ejection are referred to as selected preceding nozzles NLs and the following nozzles NF selected to perform ejection are referred to as selected following nozzles NFs.

With reference to FIG. 7, the nozzles N that are to eject droplets D are selected for respective grid points P. The nozzle N that moves above each of the grid points D is determined for the grip point D. In other words, either the preceding nozzle NL or the following nozzle NF is selected to eject a droplet D for each of the grid points D in the overlapping area S. Further, in the overlapping area S, the grid points P located rearmost in the main scanning direction are defined as non-ejecting positions of the droplets D. The other grid points P are all defined as the ejecting positions of the droplets D. The grid points P defined as the ejecting positions are represented alternately by the filled-in sections and the blank sections along the sub-scanning direction. That is, the selected preceding nozzles NLs and the selected following nozzles NFs are arranged alternately.

When the lower substrate 52a is scanned in the main scanning direction, each of the preceding inkjet heads 22L selects alternating ones of the preceding nozzles NL corresponding to the overlapping area S as the selected preceding nozzles NLs and causes the selected preceding nozzles NLs to eject the preceding droplets. Each of the preceding droplets then reaches the area corresponding to the associated one of the grid points P, which are provided in accordance with the ejection pitches Px. The preceding droplets D then form the belt-like liquefied films LF each extending in the main scanning direction.

Further, each of the following inkjet heads 22F selects alternating ones of the following nozzles NF corresponding to the overlapping area S as the selected following nozzles NFs and causes the selected following nozzles NFs to eject the following droplets. Each of the following droplets is received by the lower substrate 52a in such a manner as to cover the spaces between the portions of the liquefied films LF that have been formed by the selected preceding nozzles NLs. This joins the portions of the liquefied film LF together to complete the liquefied film LF covering the entire portion of the overlapping area S.

At this stage, the different timings of ejection by the preceding droplets and that of the following droplets cause differences in thickness (formation of streaks) at the boundaries between the preceding alignment film portions and the following alignment film portions. After having reached the overlapping area S, the preceding droplets and the following droplets regularly disperse the streaks as fine streaks in accordance with the ejection pitches Py, thus forming a uniform streaked pattern in the entire portion of the overlapping area S. Thus, in the liquid crystal alignment film 60 as a whole, which is provided in the overlapping area S after the subsequent steps, each of the boundaries between the preceding alignment film portions and the following alignment film portions is blurred so that the preceding alignment film portions and the following alignment film portions become continuous. This suppresses streaking between the preceding alignment film portions and the following alignment film portions.

### S13: Preliminary Drying

A preliminary drying treatment is then performed on the lower substrate 52a, onto which the liquid crystal alignment film forming composition has been applied. Specifically, the substrate is transported to the drying device 4 by the belt conveyor 10 and set in the drying device 4. The substrate is then dried preliminarily at, for example, 60° C. to 200° C. After such drying of the composition, the lower substrate 52a is returned to the belt conveyor 10, which then transports the lower substrate 52a to the baking device 5.

### S14: Baking

After having been subjected to the preliminary drying treatment, baking treatment is performed on the lower substrate 52a. Specifically, the substrate is transported to the baking device 5 by the belt conveyor 10 and set in the baking device 5. The substrate is then baked at, for example, 180° C. to 250° C. If the liquid crystal alignment film forming composition contains polyamic acid, dehydration ring closure is promoted by the baking treatment. As a result, a film with further promoted imidization is formed. The thickness of the film is normally 0.001 to 1 μm and, preferably, 0.005 to 0.5 μm.

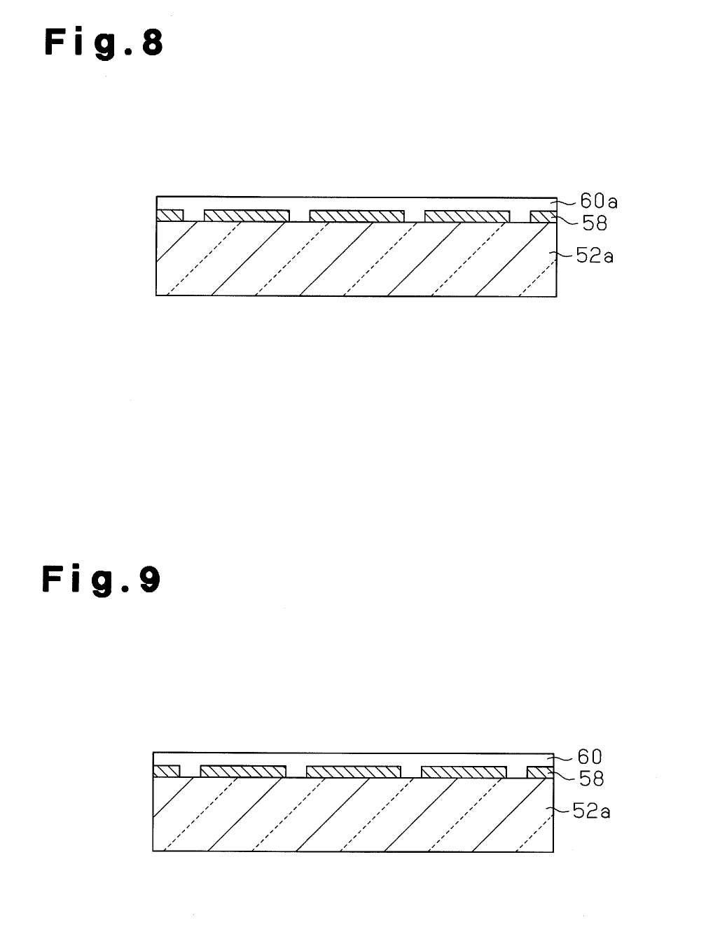

In this manner, the lower substrate 52a having a film 60a of the liquid crystal alignment film forming composition, which is shown in FIG. 8, is obtained. Since the film 60a of the liquid crystal alignment film forming composition is formed by the method according to the present invention, the film 60a is prevented from streaking and has uniform thickness and a flat surface. Subsequently, the lower substrate 52a is returned to the belt conveyor 10 and then carried to the rubbing device 6 by the belt conveyor 10.

### S15: Rubbing

Rubbing treatment is then performed on the film 60a of the liquid crystal alignment film forming composition, which has been formed on the lower substrate 52a. Specifically, the lower substrate 52a, which has been transported by the belt conveyor 10, is set in the rubbing device 6. The lower substrate 52a is then subjected to the rubbing treatment, or rubbed in a constant direction by a roll around which a cloth of fabric such as nylon, rayon, or cotton is wound. In this manner, the liquid crystal alignment film 60, the film 60a of which has orientation force of liquid crystal molecules, is formed, as shown in FIG. 9.

Although not illustrated, the visibility characteristics of the liquid crystal display element may be improved through, for example, the following treatment. Specifically, as described in Japanese Laid-Open Patent Publications Nos. 6-222366 and 6-281937, the pre-tilt angle of the formed liquid crystal alignment film 60 may be changed through radiation of ultraviolet light onto a limited part of the liquid crystal alignment film 60. Alternatively, as disclosed in Japanese Laid-Open Patent Publication No. 5-107544, a resist film may be formed on a portion of the surface of the liquid crystal alignment film 60 after the liquid crystal alignment film 60 is rubbed. Subsequently, rubbing is repeated in a direction different from the direction in which the preceding cycle of rubbing has been carried out. The resist film is then removed. In this manner, the liquid crystal orientation force of the liquid crystal alignment film 60 is changed.

After the liquid crystal alignment film 60 is completed, the lower substrate 52a is returned to the belt conveyor 10 and transported to the droplet ejection apparatus 3b by the belt conveyor 10. The lower substrate 52a is then set in the droplet ejection apparatus 3b.

### S16: Application of Seal Material

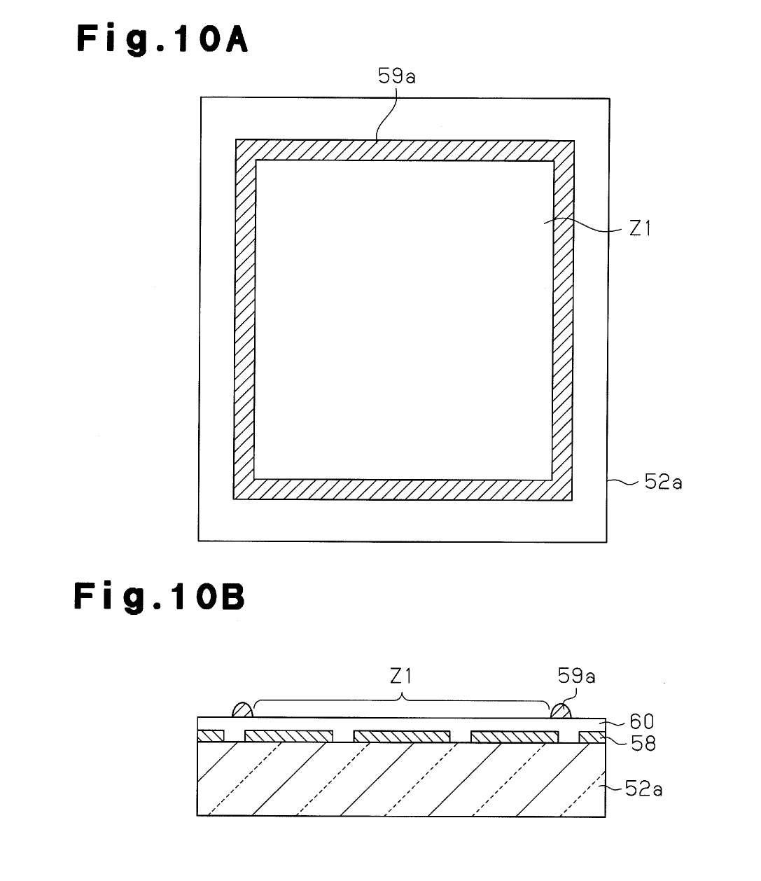

In the droplet ejection apparatus 3b, referring to FIGS. 10A and 10B, a seal layer forming solution is applied onto the liquid crystal alignment film 60, which has been rubbed, in such a manner as to encompass a liquid crystal display area (a liquid crystal layer forming area Z1). This provides a seal layer 59a. FIG. 10A shows the seal layer 59a as viewed from above and FIG. 10B shows the seal layer 59a as viewed from beside.

As the seal layer forming solution, a known composition as adhesive for bonding the lower substrate 52a and the upper substrate 52b may be used. The seal layer forming solution may be, for example, droplets containing ionizing radiation curable resin (an ionizing radiation curable resin composition) or droplets containing thermosetting resin (a thermosetting resin composition). Since the ionizing radiation curable resin composition exhibits improved workability, the composition is preferable. Neither the type of the thermosetting resin composition nor the type of the ionizing radiation curable resin composition is not particularly restricted and may be a known type.

After the seal layer forming solution is applied, the lower substrate 52a is returned to the belt conveyor 10 and then transported to the droplet ejection apparatus 3c by the belt conveyor 10. The lower substrate 52a is then set in the droplet ejection apparatus 3c.

### S17: Application of Liquid Crystal Material

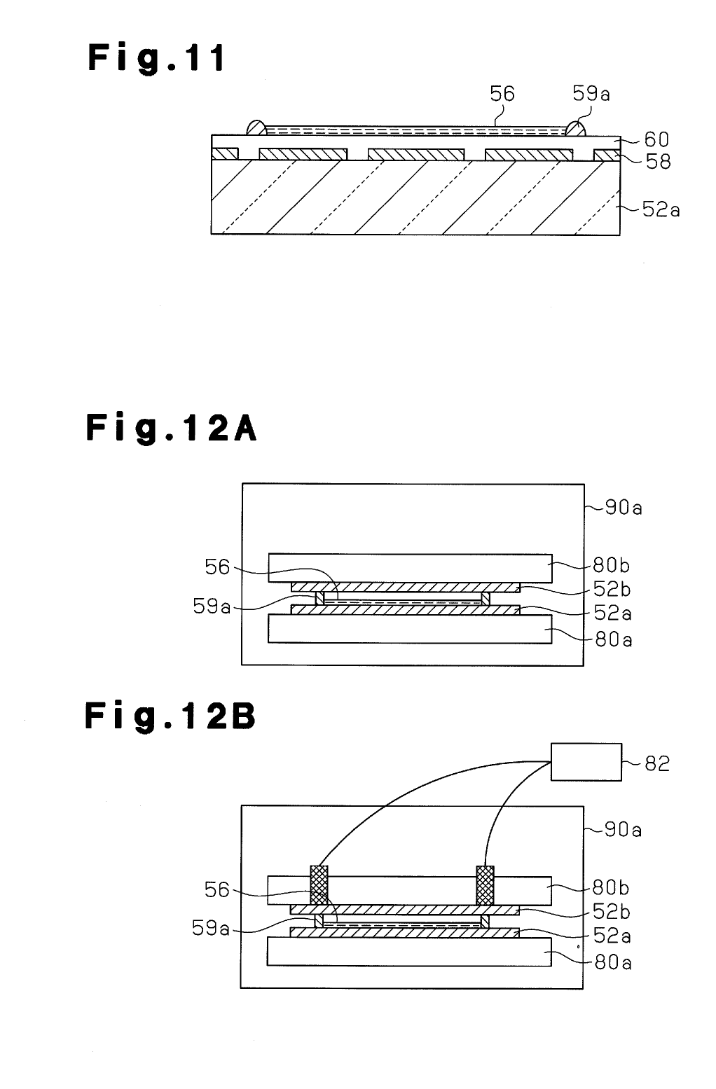

In the droplet ejection apparatus 3c, referring to FIG. 11, liquid crystal material for forming the liquid crystal layer 56 is applied onto the liquid crystal layer forming area Z1, which is encompassed by the seal layer 59a formed by a film of the seal layer forming solution. The type of the liquid crystal material is not particularly restricted and may be a known material.

The mode of liquid crystal may be, for example, TN (Twisted Nematic) type, STN (Super Twisted Nematic) type, HAN (Hybrid Alignment Nematic) type, VA (Vertical Alignment) type, MVA (Multiple Vertical Alignment) type, IPS (In Plane Switching) type, or OCB (Optical Compensated Bend) type.

The liquid crystal material may contain a spacer. The spacer maintains the thickness (the cell gap) of the liquid crystal layer at a constant level. The material of the spacer is not particularly restricted and may be a known material. Alternatively, separately from the liquid crystal material, functional liquid containing spacer may be applied before or after application of the liquid crystal material.

### S18: Bonding

With reference to FIG. 12A, after application of the liquid crystal material, the lower substrate 52a is transported into a vacuum chamber 90a of the bonding device. After vacuum is provided in the chamber 90a, the lower substrate 52a is drawn and fixed to a lower platen 80a. Then, the upper substrate 52b, on which the color filter 62, the black matrix 64, the overcoat film 66, the common electrode 68, and the liquid crystal alignment film 70 (none of these is illustrated in the corresponding drawings) have been formed, is drawn and fixed to an upper platen 80b. The lower substrate 52a and the upper substrate 52b are then bonded together.

A liquid crystal alignment film 70 is also formed on the surface of the common electrode 68, which is provided on the upper substrate 52b. Such formation of the liquid crystal alignment film 70 is performed in a manner similar to the method employed in the above-described case in which the liquid crystal alignment film 60 is formed on the lower substrate 52a. Specifically, as has been described, the common electrode 68, which is to be formed on the upper substrate 52b, exhibits surface roughness (Ra) of 2.3 nm or greater. After the common electrode 68 is provided on the upper substrate 52b, cleansing and drying are performed on the upper substrate 52b.

After such cleansing and drying, the surface of the common electrode 68 formed on the upper substrate 52b is subjected to lyophilic treatment. This further increases wettability of the liquid crystal alignment film forming composition. Thus, the liquid crystal alignment film 70 having further uniform thickness and a further flat surface is formed on the upper substrate 52b. Next, the liquid crystal alignment film forming composition is applied onto the upper substrate 52b, which has been subjected to the lyophilic treatment. As in the above-described case, the liquid crystal alignment film forming composition contains liquid crystal alignment film forming material and organic solvent and has solid content concentration of 1 to 10 wt %, viscosity of 3 to 20 mPa·s at 23° C., and surface tension of 30 mN/m.

Then, using the droplet ejection apparatus 3a having the inkjet heads 22, the alignment film 70 is formed. At this stage, the droplets D are arranged in the arrangement pattern shown in FIG. 7 and streaks are dispersed regularly as fine streaks. This forms a uniform streaked pattern on the entire portion of the overlapping area S. The upper substrate 52b is then preliminarily dried and baked. Finally, the upper substrate 52b is rubbed so as to provide the streak free liquid crystal alignment film 70 having uniform thickness and a flat surface.

Before bonding, the lower substrate 52a and the upper substrate 52b are positioned relative to each other in accordance with alignment marks provided in advance on the lower and upper substrates 52a, 52b, which are monitored through a camera. In order to improve the positioning accuracy, it is preferred that the interval between the lower substrate 52a and the upper substrate 52b be approximately 0.2 to 0.5 mm when such positioning is performed.

### S19: Curing

Subsequently, curing treatment is performed on a stacked structure formed by the lower substrate 52a and the upper substrate 52b, which are bonded together. The curing treatment is carried out using a curing device. As the curing device, an ionizing radiation device or a heating device may be used. In the illustrated embodiment, an ultraviolet ray radiating device 82 is employed. Specifically, referring to FIG. 12B, the seal layer 59a is cured through radiation of an ultraviolet ray by the ultraviolet ray radiating device 82. Then the pressure in the chamber 90a is increased to the atmospheric pressure and the lower substrate 52a and the upper substrate 52b are released from suction.

Next, a polarizing plate is bonded with the outer surface of the liquid crystal cell, or the surface exposed to the exterior of the substrates forming the liquid crystal cell. At this stage, the polarizing plate is bonded with this surface in such a manner that the polarizing direction coincides with or becomes perpendicular to the rubbing direction of the liquid crystal alignment film, which is formed on one surface of each of the substrates. The polarizing plate, which is bonded with the outer surface of the liquid crystal cell, may be a polarizing plate having a polarizing film referred to as an H film sandwiched by a protective film of cellulose acetate or a polarizing plate formed by the H film. To form the H film, polyvinyl alcohol is drawn and oriented while iodine is absorbed by the film.

In this manner, the liquid crystal display 50, which is shown in FIG. 2, is manufactured. The obtained liquid crystal display includes a streak free liquid crystal alignment film having uniform thickness and a flat surface and is a high-quality and low-cost liquid crystal display. Thus, the method for manufacturing the liquid crystal display according to the present invention greatly improves the yield and efficiently provides the high-quality liquid crystal display. Further, the boundaries in each of the liquid crystal alignment films, which are formed through ejection of droplets at different timings, are dispersed. Each liquid crystal alignment film is thus formed continuously as a whole. As a result, a high-quality, streak free liquid crystal alignment film having uniform thickness and a flat surface is further easily provided.

In the illustrated embodiment, in step S15, the liquid crystal alignment films 60, 70 are formed through the method involving the rubbing treatment. However, the liquid crystal orientation force may be provided to the film 60a by a method involving polarized radiation as described in, for example, Japanese Laid-Open Patent Publication No. 2004-163646.

In the illustrated embodiment, in step S17, the liquid crystal layer is provided through application of the liquid crystal material using the droplet ejection apparatus 3c. However, the liquid crystal layer may be formed in the following manner. Specifically, two substrates each including a liquid crystal alignment film are provided and arranged to be opposed to each other with an interval (a cell gap), in such a manner that the rubbing directions of the liquid crystal alignment films become perpendicular to or antiparallel with each other. The circumferential portions of the substrates are then bonded together using a seal material. Liquid crystal is then poured into the cell gap defined by the surfaces of the substrates and the seal material to fill the cell gap. The pouring hole is then closed to provide a liquid crystal layer.

The present invention will hereafter be explained in further detail through examples. The invention is not restricted by any of the following examples.

### EXAMPLES 1 TO 3 AND COMPARATIVE EXAMPLES 1, 2

### Preparation of Liquid Crystal Alignment Film Forming Composition A

γ-butyrolactone, N-methyl-2-pyrolidone, and butylcellosolve were mixed at the ratio of 90:5:5 (wt %) to obtain a solvent mixture. Polyimide was dissolved in the solvent, and the liquid crystal alignment film forming composition A was thus prepared. The solid content concentration of the liquid crystal alignment film forming composition A was 2 wt %. The viscosity of the composition A at 23° C. was 4.0 mPa·s. The surface tension of the composition A at 23° C. was 41 mN/m.

### Preparation of Liquid Crystal Alignment Film Forming Composition B

γ-butyrolactone, N-methyl-2-pyrolidone, and butylcellosolve were mixed at the ratio of 33.3:33.3:33.3 (wt %) to obtain a solvent mixture. Polyimide was dissolved in the solvent, and the liquid crystal alignment film forming composition B was thus prepared. The solid content concentration of the liquid crystal alignment film forming composition B was 3 wt %. The viscosity of the composition B at 23° C. was 8.2 mPa·s. The surface tension of the composition B at 23° C. was 38 mN/m.

Using a droplet ejection apparatus, the liquid crystal alignment film forming composition A or the liquid crystal alignment film forming composition B was applied onto a surface of an ITO substrate having surface roughness (Ra) shown in Table 1 in such a manner that dry thickness became 60 nm. The liquid crystal alignment film, yet to be rubbed, was thus provided.

In application of the liquid crystal alignment film forming composition on the surface of the ITO substrate, it was visually observed whether such application achieved a uniform film thickness. In Uniformity of Application column of Table 1, “1” represents that a uniform application was observed, “2” represents that a substantially uniform application was observed, and “3” represents that a uniform application was not observed. Also, the obtained liquid crystal alignment film was visually observed. The results are shown in Table 1. In Streaks Observed/Non-Observed column of Table 1, “1” represents that no streaks were observed, and “3” represents that streaks were observed.

TABLE 1

| | Surface | | Uniformity | Streaks |
|---|---|---|---|---|
| | Roughness | | of | Observed/Non- |
| | (Ra: nm) | Composition | Application | observed |
| Example 1 | 2.3 | A | 1 | 1 |
| Example 2 | 2.9 | A | 1 | 1 |
| Example 3 | 2.3 | B | 2 | 1 |
| Comparative | 1.4 | A | 3 | 3 |
| Example 1 | | | | |
| Comparative | 1.6 | A | 3 | 3 |
| Example 2 | | | | |

As is clear from Table 1, in Examples 1 to 3, uniform application of the liquid crystal alignment film forming composition was achieved. That is, in these examples, streaks were not observed in the obtained liquid crystal alignment films. Particularly, in Comparative Examples 1, 2, which used the liquid crystal alignment film forming composition A with solid content concentration of 1 to 10 wt % with respect to the composition as a whole, viscosity of 3 to 20 mPa·s, and surface tension of 30 tO 45 mN/m, improved uniformity of the films were observed. Contrastingly, in Comparative Examples 1, 2, which used the ITO substrate having the surface roughness (Ra) of 2.3 nm or greater, uniform application of the liquid crystal alignment film forming composition was not achieved and streaks were observed in the obtained liquid crystal alignment films.

### The illustrated embodiment may be modified as follows.

In the illustrated embodiment, through the arrangement pattern of the droplets D illustrated in FIG. 7, streaks formed in each overlapping area S are regularly dispersed as fine streaks in accordance with the ejection pitches Py. In this manner, a uniform streaked pattern is provided in the entire portion of the overlapping area S. This reduces streaks.

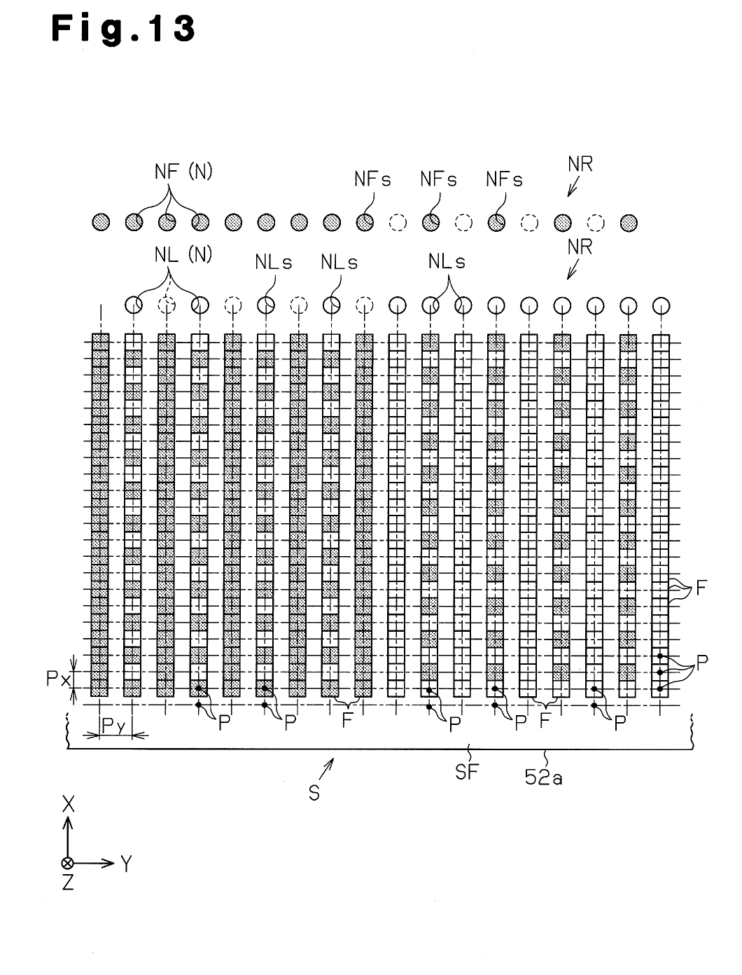

The arrangement pattern of the droplets D may be modified as illustrated in FIG. 13. With reference to FIG. 13, grid points P are defined as ejecting positions. The left side of the overlapping area S includes columns of multiple grid points P that are represented by filled-in sections extending in the main scanning direction. The side also includes columns of multiple grid points P that are represented alternately by filled-in sections and blank sections extending in the main scanning direction. The two types of columns are alternately arranged along the sub-scanning direction. The right side of the overlapping area S includes columns of multiple grid points P that are represented by blank sections extending in the main scanning direction and columns of multiple grid points D that are represented alternately by blank sections and filled-in sections extending in the main scanning direction. The two types of columns are arranged alternately in the sub-scanning direction. In this case, preceding droplets and following droplets are selectively ejected in such a manner that a block-check (checkered) pattern with the following droplets serving as the base of the pattern is formed in the left side of the overlapping area S and a block-check (checkered) pattern with the preceding droplets serving as the base of the pattern is formed in the right side of the overlapping area S.

In this manner, the block-check pattern formed by the following droplets with the preceding droplets as the base of the pattern is provided continuously from the corresponding preceding alignment film portion. Likewise, the block-check pattern formed by the preceding droplets with the following droplets as the base of the pattern is provided continuously from the corresponding following alignment film portion. Thus, the two types of block-check patterns are connected together substantially at the center of the overlapping area S in the sub-scanning direction. As a result, the boundary between the preceding alignment film portion and the following alignment film portion is formed by fine streaks extending in the main scanning direction and the sub-scanning direction.

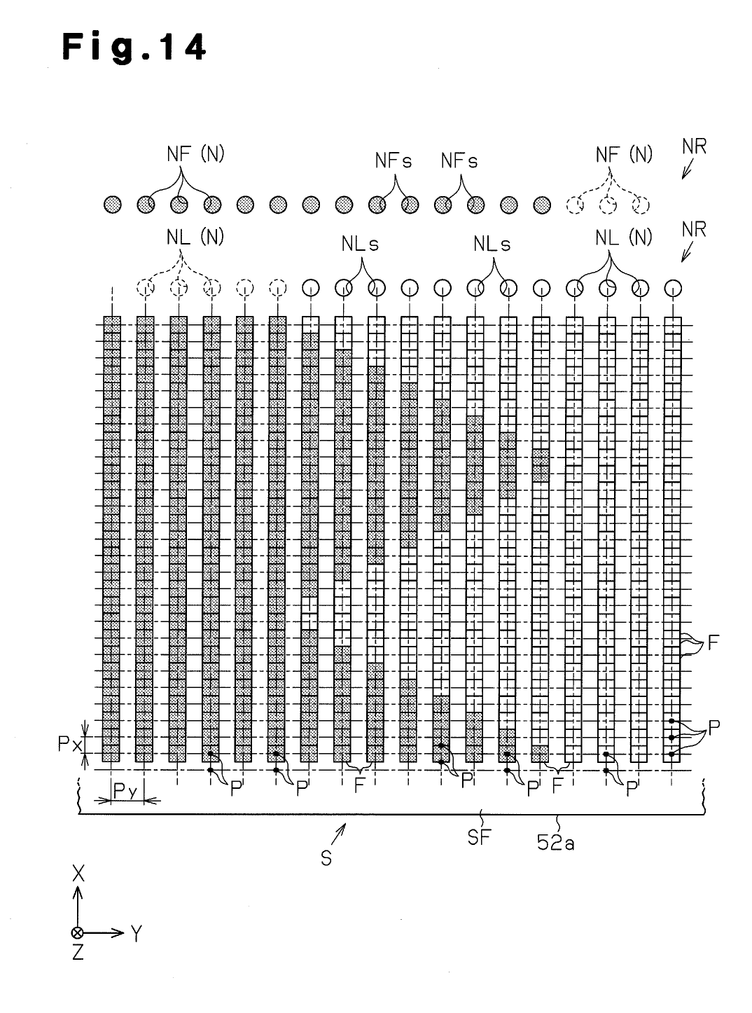

Alternatively, the arrangement pattern of the droplets D may be modified as shown in FIG. 14. With reference to FIG. 14, in the left side of the overlapping area S, rows of multiple grid points P each extending continuously in the sub-scanning direction are defined as the positions of the following nozzles NF. In the right side of the overlapping area S, rows of multiple grid points P each extending continuously in the opposite direction to the sub-scanning direction are defined as the positions of the preceding nozzles NL. The grid points P defined as the positions of the following nozzles NF that are located foremost in the sub-scanning direction are arranged at the positions changing in accordance with the ejection pitch Px by the distance corresponding to the ejection pitch Py along the sub-scanning direction. These grid points P thus form a serrated path extending continuously in the main scanning direction. In this case, preceding droplets and following droplets are selectively ejected in such a manner that the boundary between the following droplets in the left side of the overlapping area S and the preceding droplets in the right side of the overlapping area S form a continuous serrated pattern in the main scanning direction.

In this manner, the boundary between the preceding alignment film portion and the following alignment film portion is formed by a fine serrated streak extending in the main scanning direction, or fine streaks extending in a direction crossing the main scanning direction and a direction crossing the sub-scanning direction. As a result, the boundary between the preceding alignment film portion and the following alignment film portion is provided further continuously.

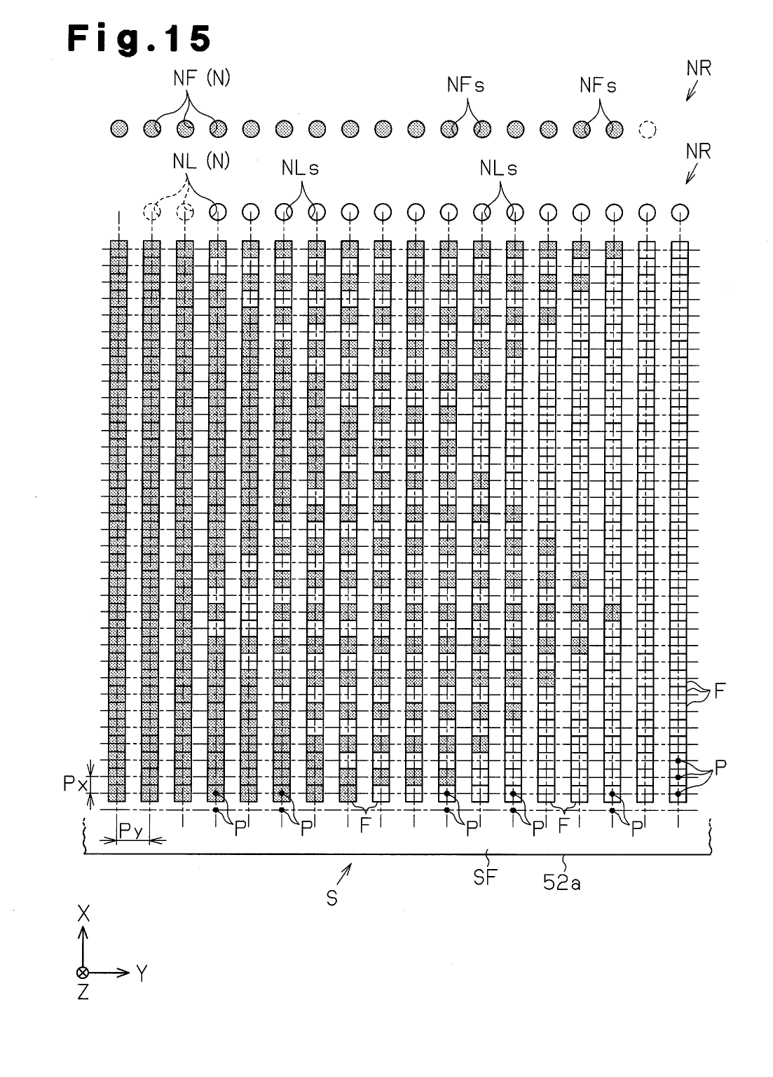

The arrangement pattern of the droplets D may be modified as shown in FIG. 15. As illustrated in FIG. 15, the boundary between the following droplets in the left side of the overlapping area S and the preceding droplets in the right side is formed in a serrated shape extending continuously in the main scanning direction. Each of the projections of the serrated shape is formed by comb-like teeth extending in the sub-scanning direction. In other words, the boundary between the preceding droplets and the following droplets is formed by the comb-like teeth that extend in the sub-scanning direction and are represented alternately by filled-in sections and blank sections and the comb-like teeth that are represented by blank sections and engaged with the other type of the comb-like teeth.

In this case, fine streaks are dispersed in the overlapping area S in multiple directions including the sub-scanning direction. Thus, the alignment film portion formed in the overlapping area S causes the boundary between the preceding alignment film portion and the following alignment film portion to become further continuous.

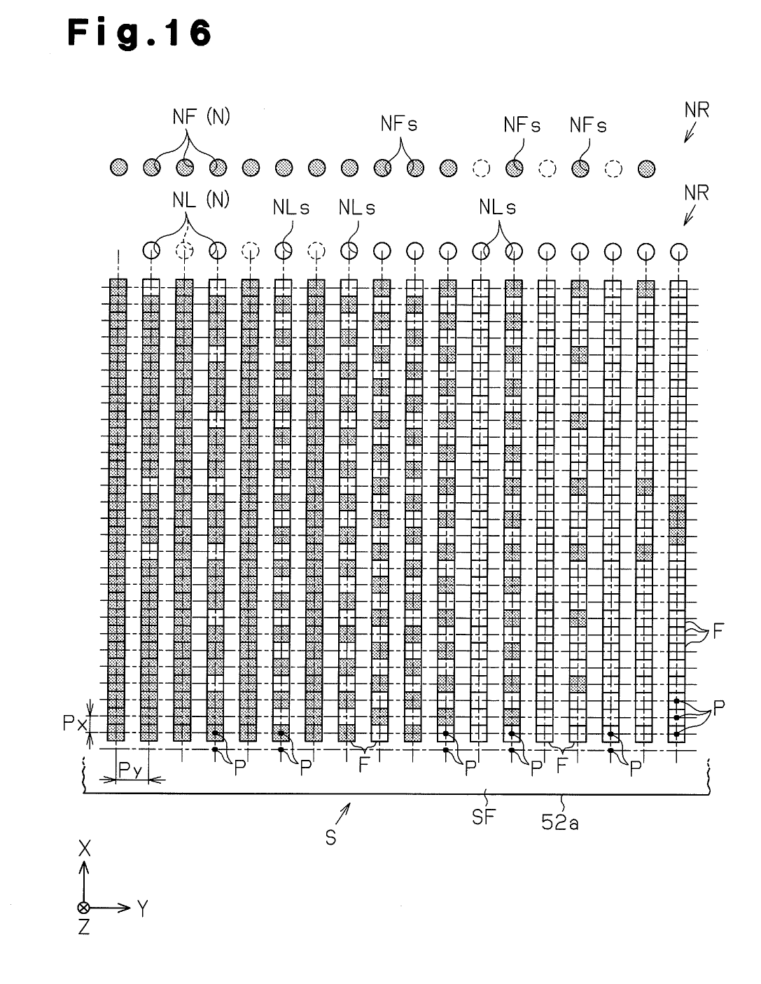

The arrangement pattern of the droplets D may be changed as illustrated in FIG. 16. Referring to FIG. 16, the comb-like teeth of FIG. 15 are divided by the striped pattern shown in FIG. 13. In this manner, the streaks are dispersed in the overlapping area S in multiple directions including the main scanning direction and the sub-scanning direction. This allows the alignment film formed in the overlapping area S to further reliably eliminate streaks between the preceding alignment film portion and the following alignment film portion.

(2) In the illustrated embodiment, the selected preceding nozzles NLs are provided alternately along the sub-scanning direction. The present invention is not restricted to this. For example, the selected preceding nozzles NLs may be provided every three or more of the preceding nozzles NL. Alternatively, the selected preceding nozzles NLs may be selected in a nonperiodic manner.

(3) In FIG. 10, the selected preceding nozzles NLs and the selected following nozzles NFs are selected alternately in accordance with the grid points P. This forms the block check (checkered) arrangement pattern. However, the invention is not restricted to this. For example, the selected preceding nozzles NLs and the selected following nozzles NFs may be selected in a nonperiodic and alternating manner.

The present invention is not limited to the illustrated embodiments but may be modified in various forms without departing from the scope of the claims. A part of each configuration of the illustrated embodiments may be omitted or the configurations may be combined as needed in a manner different from the above-described manners. Although the multiple embodiments have been described herein, it will be clear to those skilled in the art that the present invention may be embodied in different specific forms without departing from the spirit of the invention. The invention is not to be limited to the details given herein, but may be modified within the scope and equivalence of the appended claims.

1. A method for forming a functional film comprising:
preparing a substrate having a surface roughness of 2.3 nm or greater;
preparing a functional film forming composition containing a functional film forming material and an organic solvent; and
forming a functional film through ejection of the functional film forming composition onto the substrate using a droplet ejection apparatus.

2. The method according to claim 1, wherein the functional film forming composition has a solid content concentration of 1 to 10 wt % with respect to the composition as a whole, a viscosity of 3 to 20 mPa·s, and a surface tension of 30 to 45 nN/m.

3. The method according to claim 1, wherein a lyophilic treatment is performed on a surface of the substrate.

4. The method according to claim 1, wherein the substrate is a transparent substrate, a transparent conductive film being formed on a surface of the transparent substrate, a lyophilic treatment being performed on a surface of the transparent conductive film.

5. The method according to claim 1, wherein the functional film is a liquid crystal alignment film.

6. A method for manufacturing a liquid crystal display comprising:
preparing a transparent substrate having a transparent conductive film with a surface roughness of 2.3 nm or greater formed on a surface of the substrate;
preparing a liquid crystal alignment film forming composition containing a liquid crystal alignment film forming material and an organic solvent; and
forming a liquid crystal alignment film through ejection of the liquid crystal alignment film forming composition onto the transparent substrate using a droplet ejection apparatus.

7. The method according to claim 6, wherein the liquid crystal alignment film forming composition has a solid content concentration of 1 to 10 wt % with respect to the composition as a whole, a viscosity of 3 to 20 mPa·s, and a surface tension of 30 to 45 nN/m.

8. The method according to claim 6, wherein a lyophilic treatment is performed on a surface of the transparent substrate.

9. The method according to claim 6, wherein the droplet ejection apparatus includes a first nozzle group formed by a plurality of first nozzles aligned along a sub-scanning direction and a second nozzle group formed by a plurality of second nozzles aligned along the sub-scanning direction, the first nozzle group and the second nozzle group being arranged in such a manner that a portion of the first nozzle group and a portion of the second nozzle group are overlapped with each other as viewed in the main scanning direction, and
wherein the forming the liquid crystal alignment film includes forming the liquid crystal alignment film on the transparent substrate through movement of the transparent substrate relative to the first nozzle group and the second nozzle group and along the main scanning direction, and ejection of droplets from selected ones of the first nozzles and selected ones of the second nozzles, wherein droplets are ejected from a selected plurality of the first nozzles in an area of the first nozzle group overlapped with the second nozzle group as viewed in the main direction, and wherein a plurality of the second nozzles located between each adjacent pair of the selected first nozzles as viewed in the main scanning direction are selected to eject droplets.

10. The method according to claim 9, wherein droplets are ejected from a plurality the first nozzles selected in accordance with a predetermined interval in the area of the first nozzle group overlapped with the second nozzle group as viewed in the main scanning direction, and wherein a plurality of the second nozzles located between each adjacent pair of the selected first nozzles as viewed in the main scanning direction are selected to eject droplets.

11. The method according to claim 9, wherein at least a pair of a first nozzle and a second nozzle that are overlapped with each other as viewed in the main scanning direction are alternately selected to eject droplets.

12. The method corresponding to claim 9, wherein the foremost position in the sub-scanning direction of the first nozzles selected in the area of the first nozzle group overlapped with the second nozzle group as viewed in the main scanning direction is shifted at a predetermined cycle.

13. The method according to claim 6, wherein the droplet ejection apparatus includes a first nozzle group formed by a plurality of first nozzles aligned along a sub-scanning direction and a second nozzle group formed by a plurality of second nozzles aligned along the sub-scanning direction, the first nozzle group and the second nozzle group being arranged in such a manner that a portion of the first nozzle group and a portion of the second nozzle group are overlapped with each other as viewed in the main scanning direction, and
wherein the forming the liquid crystal alignment film includes forming the liquid crystal alignment film on the transparent substrate through movement of the transparent substrate relative to the first nozzle group and the second nozzle group and along the main scanning direction and ejection of droplets from selected ones of the first nozzles and selected ones of the second nozzles, wherein at least a pair of a first nozzle and a second nozzle that are overlapped with each other as viewed in the main scanning direction are alternately selected to eject droplets.

14. The method according to claim 13, wherein at least a pair of a first nozzle and a second nozzle that are overlapped with each other as viewed in the main scanning direction are alternately selected at a predetermined cycle to eject droplets.

15. The method according to claim 13, wherein consecutive ones of the first nozzles that are arranged along the sub-scanning direction in the area of the first nozzle group overlapped with the second nozzle group as viewed in the main direction, and consecutive ones of the second nozzles that are arranged along the sub-scanning direction in the area of the second nozzle group overlapped with the first nozzle group as viewed in the main direction are alternately selected at a predetermined cycle to eject droplets.

16. The method according to claim 13, wherein the foremost position in the sub-scanning direction of the first nozzles selected in the area of the first nozzle group overlapped with the second nozzle group as viewed in the main scanning direction is shifted at a predetermined cycle.
